(19) United States
(12) Patent Application Publication
(10) Pub. No.: US 2017/0066696 A1
(43) Pub. Date: Mar. 9, 2017

(54) Biochar and Fly Ash Germination Accelerant System

(71) Applicant: Ag Energy Solutions, Inc., Spokane, WA (US)

(72) Inventors: Philip W. Appel, Cheney, WA (US); Jacob M. Culley, Spokane, WA (US)

(73) Assignee: Ag Energy Solutions, Inc.

(21) Appl. No.: 14/846,030

(22) Filed: Sep. 4, 2015

(51) Int. Cl. C05F 11/00; A01C 7/06; A01C 7/08; C05G 3/00

(52) U.S. Cl. CPC C05F 11/00; C05G 3/0058; A01C 7/06; A01C 7/081

(57) ABSTRACT

A biochar and fly ash germination accelerant system for improving soil conditions for seed germination and growth. The biochar and fly ash germination accelerant system generally includes a base material comprised of activated carbon in a granular material state and a liming material combined with the base material. The liming material is comprised of a fly ash material in a powder state that coats the base material. The combination of the base material and the liming material is inserted into the soil near the seed during planting to lower the acidity of the soil surrounding the seed to accelerate germination.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

Field of the Invention

The present invention relates generally to a seed germination accelerant and more specifically it relates to a biochar and fly ash germination accelerant system for improving soil conditions for seed germination and growth.

Description of the Related Art

Any discussion of the related art throughout the specification should in no way be considered as an admission that such related art is widely known or forms part of common general knowledge in the field.

Soil acidification is increasingly becoming problematic throughout the world due to the increasing usage of chemicals for soil fertilization and weed management. Soil having pH measurements below 7 are considered acidic. Acidic soil at the seed germination depth (approximately 3-6 inches below the soil surface) can inhibit germination by damaging the seed coat and root hairs of germinating seedlings. Acidic soil also increases the available aluminum and other metals which contribute to plant phytotoxicity. In very acidic soil conditions, nutrient uptake is limited for most plants rendering those seedlings that do germinate more susceptible to disease and general frailty. Unfortunately, the soil stratifies into bands of very low pH soil at the germination depths as illustrated in an example of soil pH stratification shown in FIG. 1 of the attached drawings.

Examples of common liming materials commonly used to lower the pH of agricultural soil are limestone (calcium carbonate), dolomite (calcium/magnesium carbonate), hydrated lime (calcium hydroxide), and quicklime (calcium oxide). Calcium and magnesium silicates are also used as liming materials in some regions albeit less frequently so. The effects of various liming materials on acid soil have been documented. For example, in an article appearing in the Journal of the Science of Food and Agriculture titled “Application of different forms of calcium to tea soil to prevent aluminum and fluorine accumulation” by K F Fung and M H Wong, it is noted that “[u]nder the strongly acidic soil condition (pH 4) the majority of plants yield less due to one or more of the following reasons: aluminum (Al) toxicity, manganese (Mn) toxicity, calcium (Ca) deficiency and magnesium (Mg) deficiency. The addition of lime raises the soil pH, thereby eliminating problems such as the presence of excess (toxic) soluble Al and very slow microbial activity in acidic soil. The adsorbed acidic hydrogen ions are replaced by Ca²¹ from the lime while the released H¹ are neutralized by the carbonates or hydroxides added as lime.”

Others have studied the effects of liming materials on acid soil, as well. R. H. Robinson and D. E. Bullis discuss the effects liming materials can have on acid soil in their 1922 paper titled “Acid Soil Studies: III. The Influence Of Calcium Carbonate, Calcium Oxide, And Calcium Sulfate On The Soluble Soil Nutrients Of Acid Soils”. Robinson, et al. note, “It is generally recognized that the application of lime to an acid soil improves its texture and creates a better medium for the optimum development of nitrifying and other beneficial organisms. Lime also supplies a necessary base and changes certain elements into a more available form.” It should be noted here that while Robinson, et al. mentions that lime is generally recognized as useful for improving acid soil, this particular study was performed to “ascertain why some so called ‘acid soils’ . . . respond well to lime treatment while other soils do not . . . ”

The amount that any of the various liming materials raises soil pH is referred to as its relative neutralizing value (RNV). This value is based on a comparison to the capability of calcium carbonate (lime) to raise soil pH, thus it is alternatively referred to as the calcium carbonate equivalent (CCE). Therefore, it is expressed as a percentage of calcium carbonate, which serves as the standard (100%). CCEs for several liming materials are given in the table below:

| | | Relative |
|---|---|---|
| | | Neutralizing |
| Liming | Chemical | Value |
| Material | Name | (RNV or CCE) |
| Calcitic limestone | Calcium carbonate (CaCO₃) | 100 |
| Quicklime | Calcium oxide (CaO) | 150-175 |
| Hydrated lime | Calcium hydroxide (Ca(OH)₂) | 120-135 |
| Dolomitic lime | Calcium-magnesium carbonate | 95-108 |
| Slag | Calcium silicate (CaSiO₃) | 50-70 |

Source: Hue, N. V., J. A. Silva, G. Uehara, R. T. Hamasaki, R. Uchida, and P. Bunn. 1998. Managing manganese toxicity in former sugarcane soils on Oahu. University of Hawaii at Manoa, College of Tropical Agriculture and Human Resources, publication SCM-1. p. 7.

While it is clear that liming materials have agricultural benefit where acid soil is a concern, their use can often be cost prohibitive. Agricultural lime (CaCO₃) is a particularly expensive agent and according to the above chart has a relatively low CCE. Thus, the cost benefit of lime is significantly lower than for other liming materials. CaO has both the highest CCE and is one of the lowest cost options due to its availability in various forms. It is often available in agricultural markets in a liquefied or liquid suspended form. However, in these forms, it is particularly caustic and specialized equipment is required to apply it to agricultural soil.

One of the more intriguing sources for CaO is within an industrial waste known as paper mill fly ash (“PMFA”). PMFA can contain CaO in proportions between 14-20.5% and even as high as 41.55%, depending on the paper mill and/or paper mill product from which it is derived. Since it is a costly waste stream to manage, any value that can be gleaned from it will be net positive to the producer. Unfortunately, there have been many hurdles to overcome to make it a viable and therefore valuable agricultural acid soil ameliorant.

One of these hurdles is the proclivity of PMFA to clump or stick together. PMFA will clump-up (and therefore clog) typical feeding mechanisms due to contact with even trace sources of moisture such as elevated ambient humidity. This limits PMFA application means (and thus its usefulness to some crops entirely) to the broadcast spreading variety. However, because it is susceptible to wind drift, PMFA is inefficiently spread using these types of spreaders, even for the crops it could benefit. Broadcast spreading of PMFA results in vastly different application rates from one region of soil to the next. Even if the application rate for could be well controlled (perhaps on a day with no wind), surface application of CaO is inadequate as a soil amendment for amelioration of acid soil. In a paper titled “Effect of Surface Applications of Lime, Gypsum and Phosphogypsum on the Alleviating of Surface and Subsurface Acidity in a Soil under Pasture” C. J. Smith, M. B. Peoples, G. Keerthisinghe, T. R. James, D. L. Garden, and S. S. Tuomi discuss the effects of surface applications of various liming materials on acid soil. Their conclusions are that “lime is the most effective treatment for increasing soil pH and reducing the concentration of Al and Mn. However, the effects were mainly limited to the surface 5 cm. The deeper layers remained acidic and had high Al and Mn concentrations . . . even after 18 months.” Hence, surface application of PMFA would be of little benefit to seeds at germination depths and a method for introduction into the soil is still required to provide any benefit to them. This might be accomplished by tilling; using multiple passes to ensure it is cycled evenly to germination depth, but this expensive and cumbersome process does nothing to prevent any contained contaminants from further harming the soil.

The final nail in the coffin for use of PMFA as an acid soil ameliorant is indeed contained contaminants. Some processes used in the paper mill industry result in a PMFA that may contain heavy metals like Zn, Pb, and Cu that make it particularly ill-suited for use as ameliorant for acidic agricultural soil, which already poses a phytotoxicity problem.

Because of the forgoing inherent problems with acid soil ameliorants, there is a need for a new and improved germination accelerant capable of ameliorating the effect of acidic soil that is likewise able to turn a burdensome waste stream into a viable revenue stream.

### BRIEF SUMMARY OF THE INVENTION

Provided herein is a seed germination accelerant which includes a base material comprised of activated carbon in a granular material state and a liming material combined with the base material. The liming material is comprised of a fly ash material in a powder state that coats the base material. The combination of the base material and the liming material is inserted into the soil near the seed during planting to lower the acidity of the soil surrounding the seed to accelerate germination.

An object is to provide an acid soil ameliorant as a means for commoditizing one or more waste streams.

A further object is to provide a biochar and paper mill fly ash germination accelerant for amelioration of the effects of acidic soil on seed germination.

Another object is to provide a biochar and paper mill fly ash germination accelerant for amelioration of the effects of acidic soil at a seed germination depth within the soil.

Another object is to provide a biochar and paper mill fly ash germination accelerant for amelioration of the effects of acidic soil on cereal grain or legume seed germination.

A further object is to provide a biochar and paper mill fly ash germination accelerant for amelioration of the effects of acidic soil on seed germination, where the ameliorated effect is that of soil pH banding.

A further object is to provide a biochar and paper mill fly ash germination accelerant in a ratio that is best suited for amelioration of the effects on seed germination for a particular acidic level present in a soil.

A further object is to provide a biochar and paper mill fly ash germination accelerant for amelioration of the effects of acidic soil on seed germination where the ameliorated effect is that of metal ion phytotoxicity.

A further object is to provide a biochar and paper mill fly ash germination accelerant for amelioration of the effects of acidic soil on seed germination where the ameliorated effect is that of time to emergence.

A further object is to provide a biochar and paper mill fly ash germination accelerant for amelioration of the effects of acidic soil on seed germination where the biochar originates from an onsite mobile gasifier unit.

A still further object is to provide a biochar and paper mill fly ash germination accelerant for amelioration of the effects of acidic soil on seed germination, where the biochar originates from an onsite mobile gasifier unit that has processed residual biomass originating from organic matter that once grew in the target soil.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an illustration showing an example of stratified pH bands in soil.

FIG. 2 is a chart illustrating germination rates recorded by the applicant.

FIG. 3 is a block diagram illustrating the mixing of the base material with the liming material.

FIG. 4 is a magnified view of the outer porous surface of a particle of the base material.

FIG. 5 is a magnified view of the outer porous surface of the particle of the base material shown in FIG. 4 coated with the liming material.

FIG. 6 is an upper perspective view of a plurality of seed furrows with the germination accelerant composition positioned within near the seed.

FIG. 7 is a magnified end view of a seed furrow with the germination accelerant composition positioned within near the seed.

FIG. 8 is a block diagram of one type of seed planter suitable for usage with respect to the present invention.

FIG. 9a is an end cross sectional view of the seed furrow with the germination accelerant composition near the seed and fertilizer.

FIG. 9b is an end cross sectional view of a seed furrow formed as a cross-slot with the seed positioned with the germination accelerant composition and the fertilizer positioned on the opposite side of the cross-slot.

FIG. 10 is a flowchart illustrating the overall process of manufacturing the germination accelerant composition.

### DETAILED DESCRIPTION OF THE INVENTION

### A. Overview.

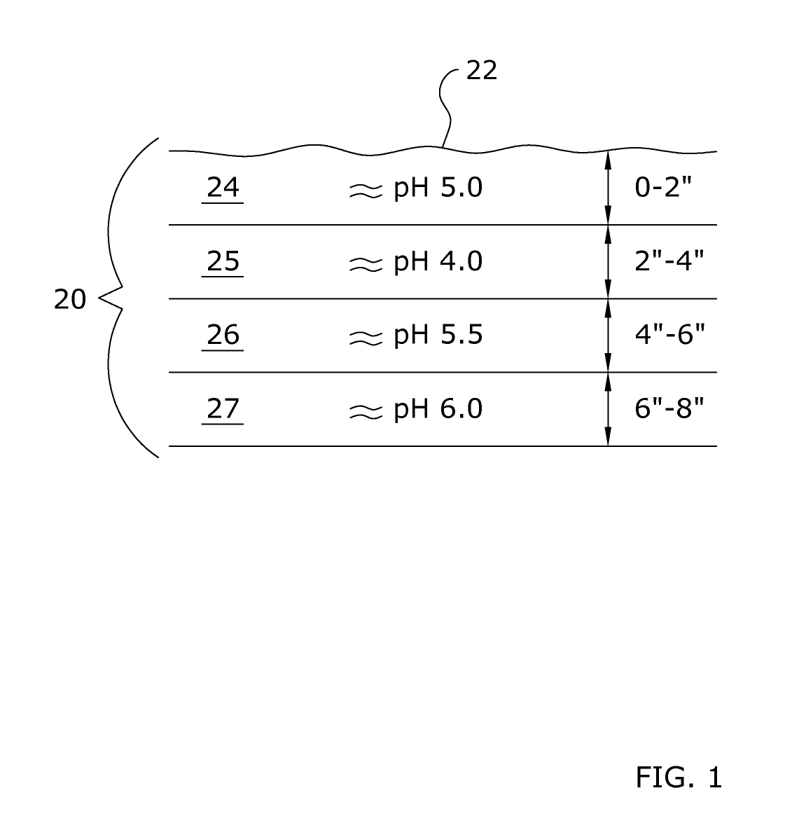

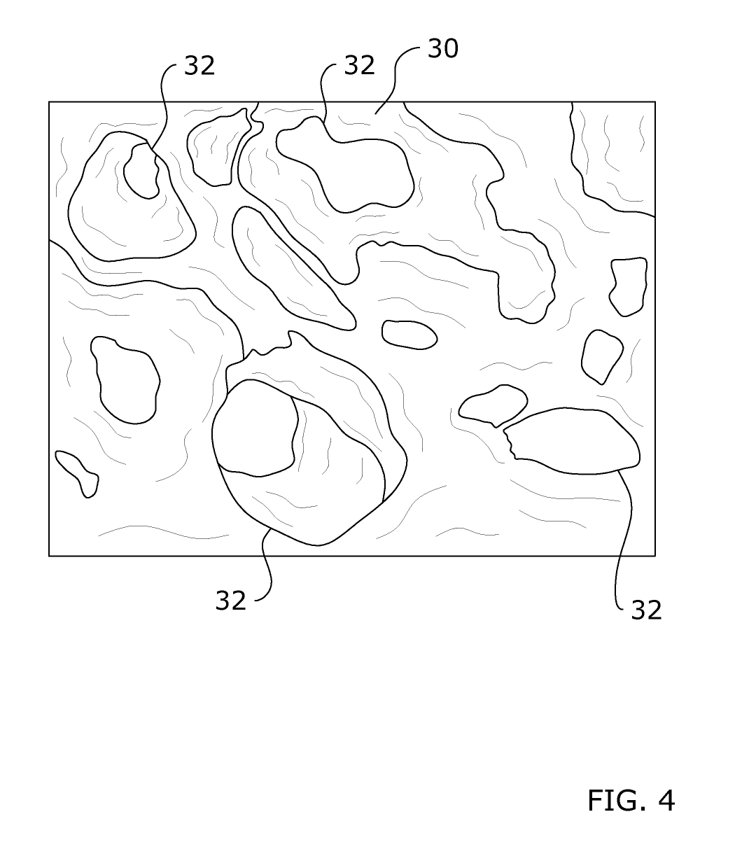

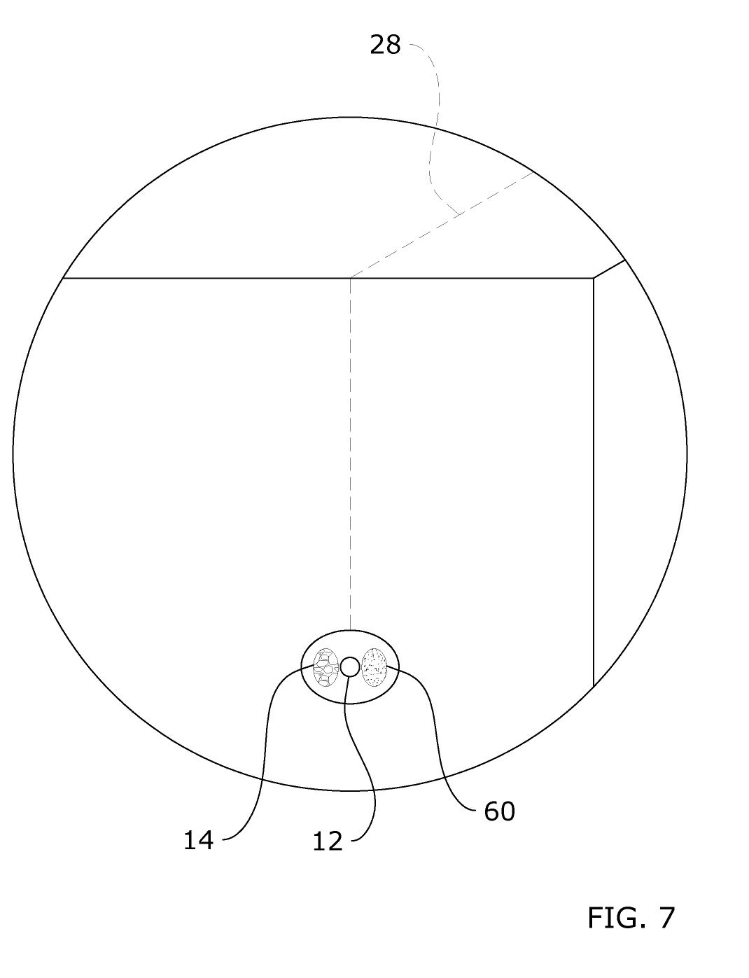

Turning now descriptively to the drawings, in which similar reference characters denote similar elements throughout the several views, FIGS. 1 through 10 illustrate a biochar and fly ash germination accelerant system, which comprises a base material 30 comprised of activated carbon in a granular material state and a liming material 40 combined with the base material 30. The liming material 40 is comprised of a fly ash material in a powder state that coats the base material 30. The combination of the base material 30 and the liming material 40 is inserted into the soil 20 near the seed 12 during planting to lower the acidity of the soil 20 surrounding the seed 12 to accelerate germination.

### B. Base Material.

The base material 30 is used as a carrier for the liming material 40 during application to the soil 20 to prevent clumping of the liming material 40 in the farming equipment such as a seeder 70. The base material 30 carries the liming material 40 below the soil surface 22 to be deposited where the seeds are more negatively affected by soil acidification. The combination of the base material 30 with the liming material 40 introduces the liming material 40 into the subsurface seed zone instead of just treating the soil surface 22 with the liming material 40.

The base material 30 is a particulate material and is further preferably comprised of a granular material. The particles of the base material 30 preferably do not have a consistent shape and are further preferably not circular in shape. The outer surface for each of the particles is preferably irregular in shape having a large surface area with a plurality of pores 32. The particles in the base material 30 have a high-porosity to maximize the total surface area of the particles. The particles of the base material 30 are further rigid in structure so as to not expand or contract significantly when the liming material 40 is attached to the base material 30.

The base material 30 is preferably comprised of activated carbon (a.k.a. activated charcoal). The activated carbon has a high-porosity suitable for usage in the present invention to receive the liming material 40. The pores 32 of the activated carbon are comprised of macropores (>50 nm diameter), mesopores (2-50 nm diameter) and micropores (<2 nm diameter). The activated carbon is preferably comprised of biochar, wherein the biochar is preferably created by pyrolysis of a biomass material (e.g. crop material, straw, wheat straw, wood material, manure). U.S. Publication No. 2015/0059245 A1 to Appel et al. discloses Apparatuses, Systems, Mobile Gasification Systems, and Methods for Gasifying Residual Biomass that is suitable for producing biochar for the present invention and is hereby incorporated by reference herein in its entirety.

The base material 30 is comprised of activated carbon, such as biochar, produced by a downdraft gasifier. The production of the biochar from biomass via a downdraft gasifier provides a higher carbon content for the base material 30 (approximately ˜70% carbon, ˜7% potassium with the balance being silica (SiO₂). In addition to grid power and/or local power, gasification of residual biomass by mobile gasification system may produce a byproduct. By product may include activated charcoal (e.g., biochar) or fly ash, which may be sold or added back to the field as a fertilizer. For example, biochar may be used for soil remediation and may increase water retention and nutrient retention. By adding biochar to the soil, watering and fertilizer costs may be reduced. The entire cycle is comprised of the following steps performed in order: (a) planting seed in the soil 20 of a field, (b) growing the plants in the field, (c) harvesting the crop from the field, (d) collecting/accumulating residual biomass from the harvesting step, (e) chopping/shredding the collected residual biomass, (f) gasifying the residual biomass, (g) collecting the biochar from the gasification process, (h) mixing the biochar with the paper mill fly ash (“PMFA”) to thoroughly coat the biochar with the PMFA, (i) applying the resulting composition of biochar/PMFA into the soil, and (j) repeating the above steps.

Biochar is a preferred base material 30 for the present invention, which has various benefits when used in a crop field. For example, biochar adsorbs excess aluminum to prevent the aluminum from being absorbed by the plant. Biochar also adsorbs nitrogen based fertilizer material 14 and then slowly releases the fertilizer material 14 over a period of time to provide a sustained release of the fertilizer material 14 to the seed 12 during the germination process and during the growth of the plant. Biochar also prevents acid fluxes that occur from applying fertilizer material 14 to soil 20. Biochar also absorbs and retains moisture to provide a sustained release of moisture to the seed 12 during germination and to the plant during growth. Biochar also buffers the change in pH of the soil 20 thereby avoiding shocking the pH of the soil 20 which can kill desirable bacteria and microbes. Biochar has a high surface area and can absorb smaller particles without increasing in volume. Biochar is also less sticky and tends to flow more readily than powder materials such as fly ash. By inoculating the biochar with paper mill fly ash, the nutrient quality of the biochar is improved and the fly ash is applied to the soil 20 without the physical constraints of its stickiness.

### C. Liming Material.

The base material 30 is coated and inoculated with the liming material 40 in a manner to substantially coat the granular material of the base material 30. The liming material 40 is comprised of a material that neutralizes and lowers the acidity of soil 20 thereby lowering the pH of the soil 20. The liming material 40 further preferably adds calcium and magnesium to the soil 20.

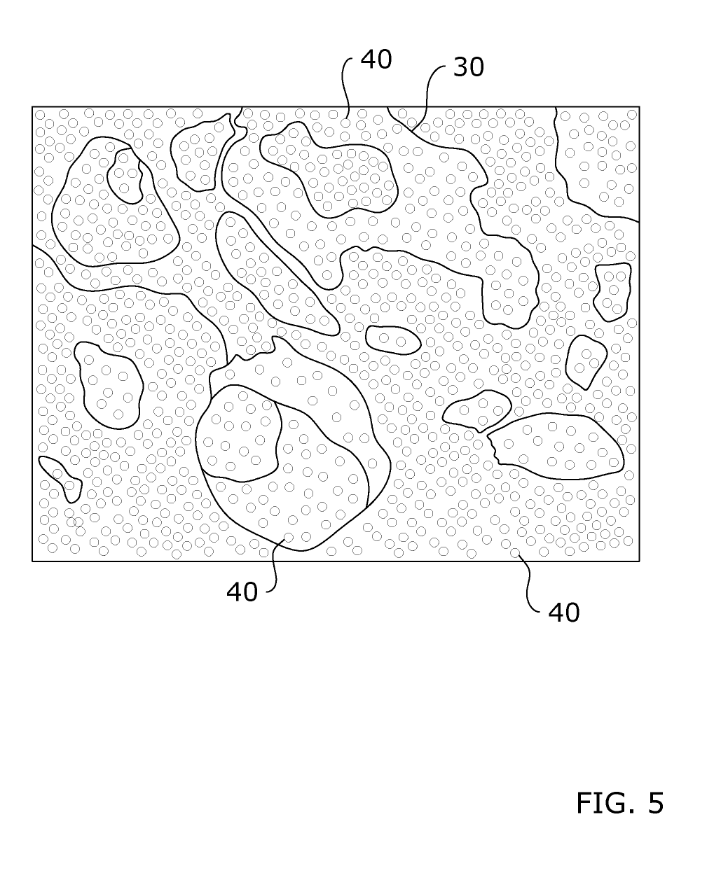

The liming material 40 is preferably comprised of a powder material having a small particle size compared to the base material 30. The particles of the liming material 40 are small enough to fit within the pores 32 of the base material 30 as illustrated in FIG. 5 of the drawings. The small particle size of the liming material 40 allows the liming material 40 to coat a substantial portion of the outer surface of the particles of the base material 30.

Various types of liming agents may be used for the liming material 40. In addition to liming agents, other types of chemicals may be used to coat the base material 30 alone or in combination with the liming material 40 such as, but not limited to, powdered fungicides, powdered fertilizers and the like.

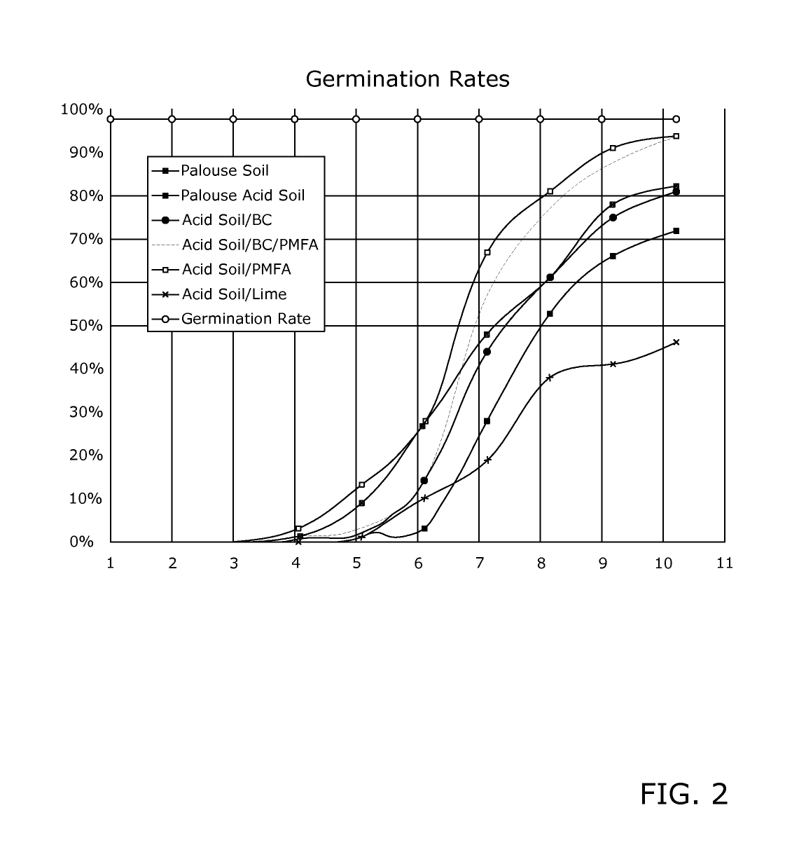

The liming material 40 is preferably comprised of a fly ash material and is further preferably comprised of a paper mill fly ash, which the inventors have found to provide desirable results in the soil 20 during the germination of seed 12. The paper mill fly ash is preferably produced using a fluidized bed gasifier. The paper mill fly ash is preferably produced using recycled paper in the fluidized bed gasifier. Paper mill fly ash material is a preferable material for the liming material 40 because it increases the germination rate and decreases the time for emergence as illustrated in FIG. 2 of the drawings. FIG. 2 illustrates the results of preliminary studies by the applicant (refer to the line represented by “Acid Soil/PMFA”). As an additional benefit, paper mill fly ash is significantly cheaper than other types of liming products currently available. In addition, paper mill fly ash produced using a fluidized bed gasifier does not include any significant amounts of heavy metals unlike fly ash created by other processes.

Unfortunately, paper mill fly ash does not feed well through agricultural equipment such as seeders 70 due to the high angle of repose and particle adhesion. However, the inventors have found that applying the paper mill fly ash to biochar results in the biochar being a suitable carrier for conveying of the paper mill fly ash into the soil 20 because of the high porosity of biochar. The paper mill fly ash bonds to the biochar due to the lodging of the fly ash into the pores 32 of the biochar and the static bonds formed on the surface of the biochar.

Calcium oxide (CaO) is a component of paper mill fly ash in percentages as high as 41.55% or more. When paper mill fly ash is mixed with biochar at appropriate ratios (discussed further below), it has been discovered that germination rates of certain seeds may increase as illustrated in FIG. 2 and time to emergence may decrease in acidic soils. The CaO within the paper mill fly ash neutralizes the acidic soil components and adds depleted calcium to the soil 20, while the biochar adsorbs excess aluminum and other heavy metal ions within both the soil 20 and the bulk paper mill fly ash constituents. Thus, damage to roots due to metal ions is minimized and young plant productivity is strengthened. The mixture described herein yields an additional benefit in that the biochar component is able to adsorb nitrogen. Therefore, when the mixture is placed at germination depth, it can adsorb nitrogen starter placed near the seed 12 and provide a sustained release of the needed nutrients, while preventing acid fluxes inherent to chemical fertilization.

These and other benefits may be achieved while making use of two waste streams: paper mill fly ash from industrial processing of paper in a paper mill, and biochar resultant from gasification of residual biomass. Both are readily available at a fraction of the cost of traditionally used soil amendments. Furthermore, recent developments in mobile biomass gasification, enables onsite production of biochar to use in the mixture as disclosed and incorporated herein by U.S. Publication No. 2015/0059245 A1 to Appel et al.

### D. Manufacturing the Seed Germination Accelerant.

The percentages of materials used in composition 60 are based on weight percentages (i.e. the weight of the material) and not the volume of material. The ratio of liming material 40 to the base material 30 may be from 50:50 (liming material: base material) ratio based on weight of the materials to 10:90 based on the weight of the materials. The preferred ratio is approximately 25:75 liming material to base material based on weight, wherein the liming material is preferably comprised of paper mill fly ash and the base material is preferably comprised of biochar.

The base material 30 is preferably present in an amount from about 55 to about 90 weight percent and the liming material 40 is present in an amount from about 10 to about 45 weight percent when used with respect to agricultural equipment such as seeders 70 to limit the impact of the liming material 40's negative physical properties. For example, if a 100 lbs of germination accelerant composition 60 is to be produced, the base material 30 would be approximately 65 lbs to 90 lbs of the total weight of the 100 lbs of germination accelerant composition 60 and the liming material 40 would be approximately 10 lbs to about 45 lbs of the total weight of the 100 lbs of germination accelerant composition 60 assuming no other materials are to be included in the composition. As a further example relating to the 100 lbs of total germination accelerant composition 60, if 80 lbs of base material 30 is used then 20 lbs of liming material 40 would be used in the composition.

The base material 30 is preferably present in an amount from about 65 to about 85 weight percent and the liming material 40 is preferably present in an amount from about 15 to about 35 weight percent. The inventors have found that liming material 40 in the amount of about 15 to about 25 weight percent with the remainder of the composition 60 being comprised of the base material 30 provides the desirable particulate material properties for use in agricultural equipment without plugging delivery tubes while providing desirable effects on the soil 20 surrounding the seed 12. For example, if 20 lbs of paper mill fly ash is used in the composition 60, then approximately 80 lbs of biochar would be used to produce a 20/80 weight percentage ratio.

In applications not using agricultural equipment where the physical properties of the composition 60 are less important, weight percentages of liming material 40 greater than 45 weight percent may be used. For example, if the composition is being applied manually within a nursery setting, the amount of liming material 40 in the composition 60 may be 50 weight percent or greater.

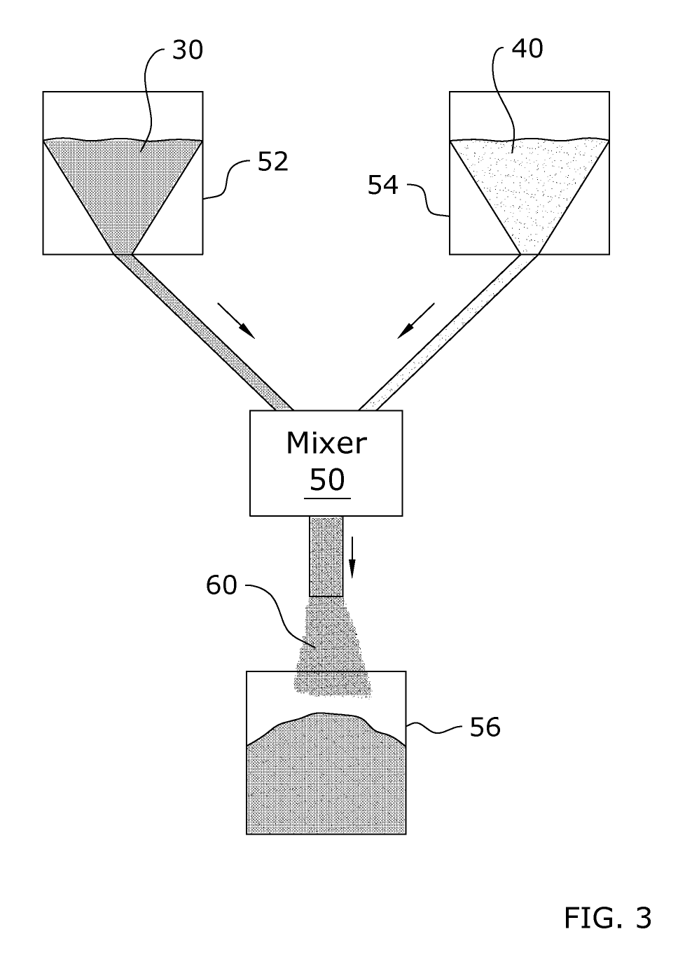

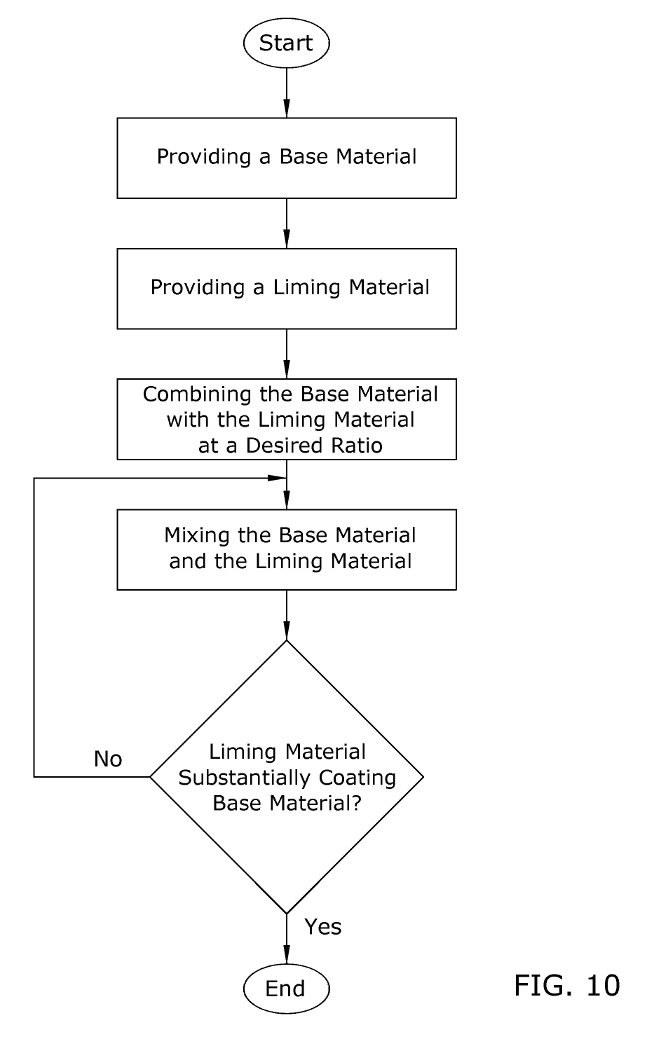

FIG. 3 illustrates a mixer 50 being used to combine and mix the base material 30 of activated carbon with the liming material 40 to form the seed germination accelerant composition 60. As illustrated in FIG. 10, a desired amount of base material 30 from a first container 52 is conveyed to the mixer 50 and a desired amount of liming material 40 from a second container 54 is conveyed to the mixer 50 for mixing together. After the base material 30 is mixed with the liming material 40, the resulting germination accelerant composition 60 is conveyed to a storage container 56 for storage until needed during planting of a field. It is preferable that the biochar is formed at the site or near the site of the farmer as disclosed in U.S. Publication No. 2015/0059245 A1 to Appel et al.

The mixer 50 may be comprised of any type of equipment capable of thoroughly mixing two or more types of particulate material together in a thorough manner so as to substantially coat the outer surface of the base material 30 with the liming material 40. It is preferable that the mixer 50 is comprised of a tumble mixer which the inventors have found suitable for coating and/or inoculating the biochar with the paper mill fly ash. However, other types of mixers 50 may be used such as, but not limited to, auger mixers and cyclonic mixers. The amount of mixing time required depends upon the percentages of base material 30 and liming material 40 used along with various other factors to result in the desired composition 60. During the mixing, the paper mill fly ash penetrates the pores 32 of the biochar as illustrated in FIG. 5 of the drawings.

### E. Using the Composition to Assist in Seed Germination.

FIG. 1 illustrates an example of how soil 20 stratifies into different bands of pH levels such as the first band 24 having a pH level of 5.0, the second band 25 having a pH level of 4.0, the third band 26 having a pH level of 5.5 and the fourth band 27 having a pH level of 6.0. Seeds are typically planted 3-6 inches below the soil surface 22 which is typically where the higher acidity levels exist in the soil 20.

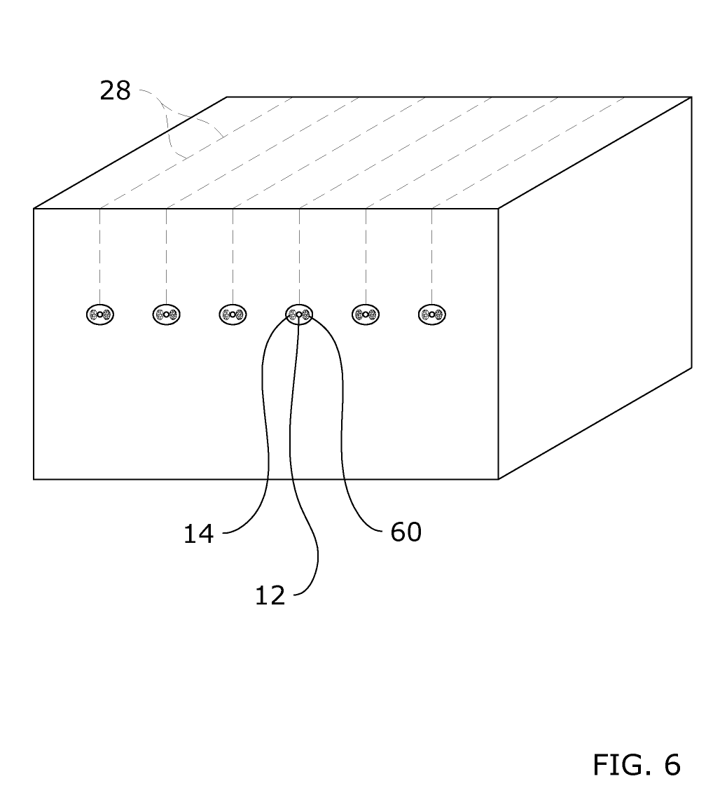

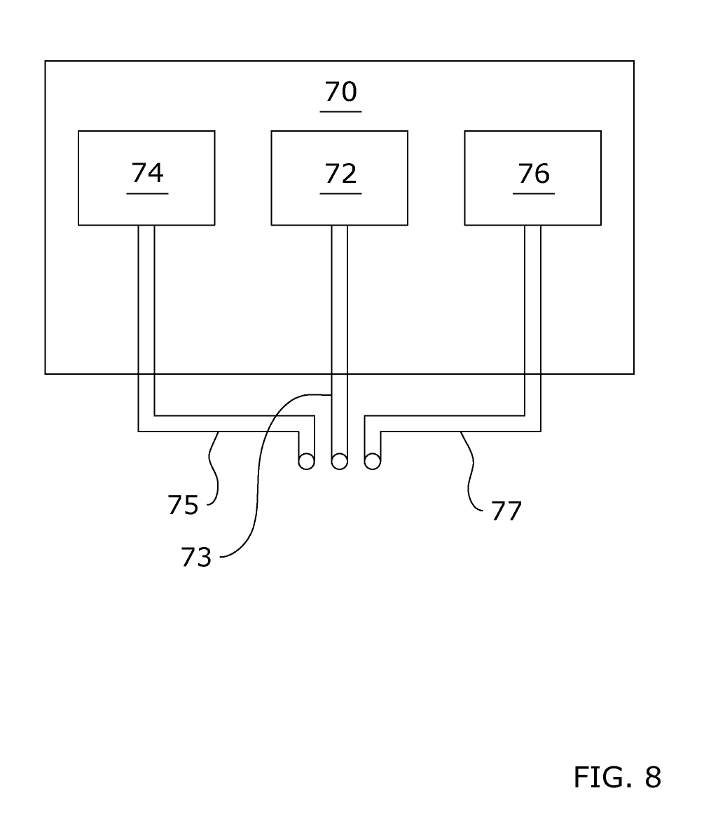

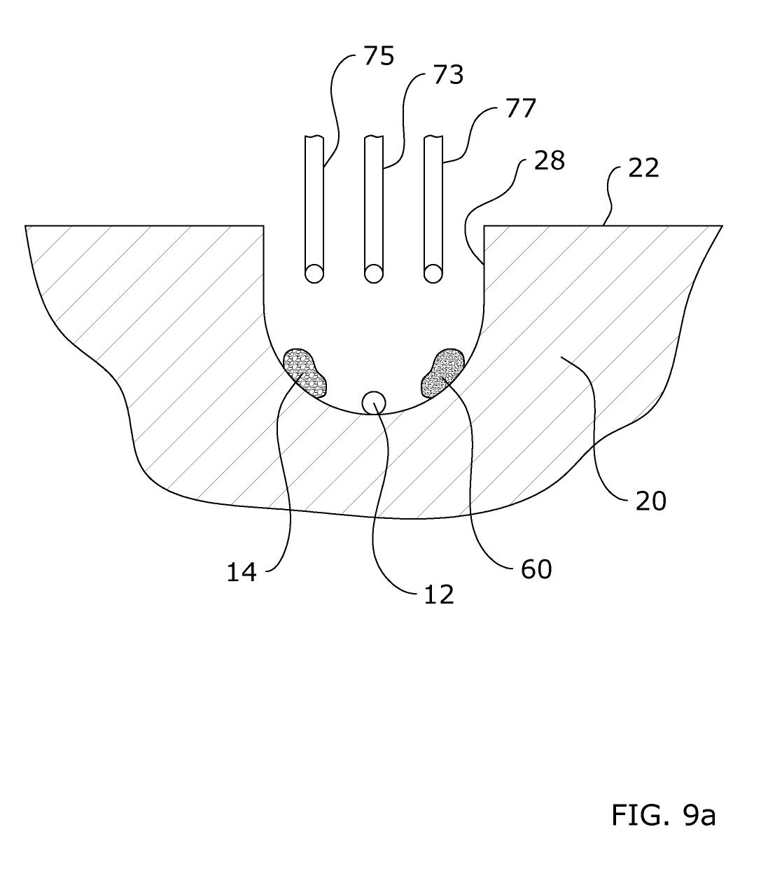

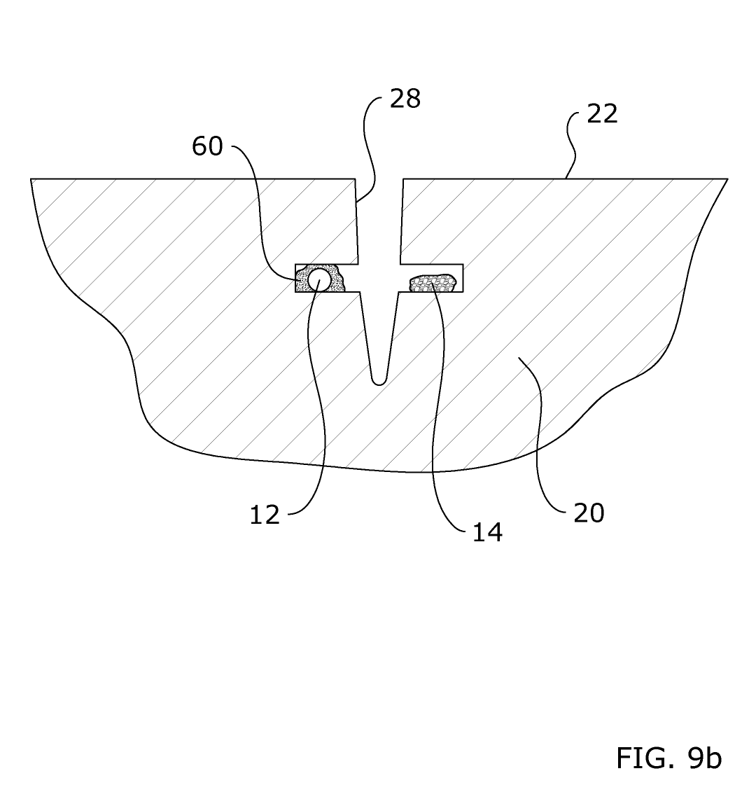

FIGS. 6, 7, 9a and 9b illustrate the germination accelerant composition 60 positioned near the seed 12 in the seed furrow. FIG. 8 illustrates a block diagram for a conventional seeder 70 (e.g. seed planter, air seeder 70) having a fertilizer container 74 (liquid or particulate material), a seed container 72 and an accelerant container 76 for storing the composition 60. The seed 12 is discharged into the seed furrow via the seed tube 73, the fertilizer material 14 is discharged into the seed furrow via the fertilizer tube 75 and the composition 60 is discharged into the seed furrow near the seed 12 via the accelerant tube 77 as illustrated in FIGS. 8, and 9a. The composition 60 may be used in various types of seed furrows such as a conventional trough type furrow as illustrated in FIG. 9a that is covered up or a furrow having a cross shape using a CROSS SLOT® brand of no-tillage planting using a seed drill manufactured by Baker No-Tillage Ltd. While the composition 60 is preferably kept separate from direct contact with the fertilizer material 14 to avoid chemical reactions, the composition 60 may be mixed with the seed 12 directly in the seed container 72 and delivered together with the seed 12 to the seed furrow during planting via the seed tube 73. The composition 60 is preferably near or surrounding the seed 12 in the seed furrow to provide the maximum benefits of the composition 60. If the composition 60 is discharged separate from the seed 12 by the seeder 70, then using GPS technology combined with soil testing a control unit can automatically increase or decrease the rate of application of the composition 60 based upon the soil measurements in specific areas of the field being planted. Because the composition 60 is near the seed 12 (preferably within the 3-6 inch planting band), the acidity of the soil 20 in the area surrounding the seed 12 is lowered sufficiently to a desirable pH level to assist in germination of the seed 12. The other benefits of the composition 60 comprised of the biochar and paper mill fly ash are further described above thereby assisting in the growth of the plant during all phases.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A seed germination accelerant composition, comprising:
a base material comprised of activated carbon, wherein said base material is a granular material; and
a liming material, wherein said liming material is comprised of a powder material that lowers the acidity of soil.

2. The seed germination accelerant composition of claim 1, wherein said base material has a high-porosity.

3. The seed germination accelerant composition of claim 1, wherein said base material is comprised of biochar.

4. The seed germination accelerant composition of claim 3, wherein said biochar is produced from biomass.

5. The seed germination accelerant composition of claim 1, wherein said base material is comprised of activated carbon produced by a downdraft gasifier.

6. The seed germination accelerant composition of claim 1, wherein said liming material substantially coats said granular material.

7. The seed germination accelerant composition of claim 1, wherein said liming material is comprised of fly ash.

8. The seed germination accelerant composition of claim 7, wherein said liming material is comprised of paper mill fly ash.

9. The seed germination accelerant composition of claim 8, wherein said liming material is comprised of paper mill fly ash produced by a fluidized bed gasifier.

10. The seed germination accelerant composition of claim 9, wherein said base material is present in an amount from about 55 to about 90 weight percent and wherein said liming material is present in an amount from about 10 to about 45 weight percent.

11. The seed germination accelerant composition of claim 9, wherein said base material is present in an amount from about 65 to about 85 weight percent and wherein said liming material is present in an amount from about 15 to about 35 weight percent.

12. A method of using said seed germination accelerant composition of claim 1, comprising:
positioning said seed germination accelerant composition in a seeder;
positioning a volume of seed in said seeder; and
planting a field with said seed planter so that said seed germination accelerant is near said seed.

13. The method of claim 12, wherein said seeder is comprised of an air seeder.

14. A method of preparing a seed germination accelerant composition, comprising:
providing a base material comprised of activated carbon;
providing a liming material; and
mixing said base material and said liming material to form a seed germination accelerant composition, wherein said base material is present in an amount from about 65 to about 85 weight percent and wherein said liming material is present in an amount from about 15 to about 35 weight percent.

15. The method of claim 14, wherein said base material is comprised of a granular material having a high-porosity.

16. The method of claim 15, wherein said base material is comprised of biochar.

17. The method of claim of claim 14, wherein said liming material is comprised of a powder material that lowers the acidity of soil.

18. The method of claim 17, wherein said step of mixing is comprised of mixing said base material and said liming material until said liming material substantially coats said base material.

19. The seed germination accelerant composition of claim 18, wherein said liming material is comprised of fly ash.

20. The seed germination accelerant composition of claim 19, wherein said liming material is comprised of paper mill fly ash produced by a fluidized bed gasifier.
